(19) United States
(12) Patent Application Publication
(10) Pub. No.: US 2026/0242615 A1
(43) Pub. Date: Aug. 20, 2026

(54) A METHOD FOR FLOATING MICROSPHERES IN A (METH)ACRYLIC POLYURETHANE COPOLYMER AND ARTICLES THEREOF

(71) Applicant: 3M INNOVATIVE PROPERTIES COMPANY, St. Paul, MN (US)

(72) Inventors: Benjamin R. Coonce, South St. Paul, MN (US); Chad M. Amb, Mayville, ND (US); Matthew J. Bruzek, Woodbury, MN (US); Susannah C. Clear, Hastings, MN (US); Cheryl L.S. Elsbernd, Woodbury, MN (US); Timothy M. Gillard, St. Paul, MN (US); Todd D. Jones, St. Paul, MN (US)

(21) Appl. No.: 19/159,346

(22) PCT Filed: Apr. 8, 2024
(86) PCT No.: PCT/IB2024/053447

§ 371 Date: Aug. 25, 2025

Related U.S. Application Data
(60) Provisional application No. 63/497,817, filed on Apr. 24, 2023.

(51) Int. Cl. C09D 5/33; C08G 18/67; C09D 7/40; C09D 7/61; C09D 175/14

(52) U.S. Cl. CPC C09D 5/004; C08G 18/672; C09D 7/61; C09D 7/69; C09D 7/70; C09D 175/14

(57) ABSTRACT

Described herein is a process for making an article and articles thereof. The process comprises: applying a curable composition to a substrate to form a coated substrate. The curable composition comprises a blend of a polyol; a polyisocyanate; a functionalized (meth)acrylate comprising at least one functional group, wherein the functional group is selected from an isocyanato or hydroxy group; and a photoinitiator. The coated substrate is partially cured with actinic radiation and then a plurality of microspheres is applied to the partially cured coated substrate. The plurality of microspheres is allowed to sink into the partially cured composition and then the substrate is thermally cured to form a beaded film.

### TECHNICAL FIELD

Disclosed herein is a process for making an article comprising partially embedded microspheres in a polymeric substrate utilizing a multi-step cure system. Such beaded film articles may find utility as pavement markings and pavement sheeting.

### BACKGROUND

Beaded retroreflective sheeting used in the manufacture of pavement markings, and retroreflective paints can include transparent microspheres adhered through the use of a binder. The microspheres act as lenses which focus the light onto a reflector, such as diffusely reflecting pigment, and once the light has been reflected off the reflector, the microspheres again act as lenses to resend the light back toward the incoming light source. In order to contribute the desired retroreflective property, however, it is important that a layer of microspheres be present on the surface of the binder layer.

As discussed in U.S. Pat. No. 3,222,204 (Victor et al.), ordinary glass beads tend to sink into the uncured liquid binder layer. In instances wherein the individual beads are not entirely submerged, the optical properties of the bead can also be impaired by the binder wetting out the bead surface and spreading on the exposed bead surface. To address this problem, various solutions have been proposed. U.S. Pat. No. 3,222,204 teaches coating the glass beads with a thin surface coating of an oleophobic fluorocarbon sizing agent. U.S. Pat. No. 4,713,295 (Laroche) teaches coating glass beads with a mixture of substances. The mixture comprises a first substance, which if used alone would tend to make the beads hydrophobic while leaving them oleophobic and a second substance, which if used alone, would tend to make the beads both hydrophobic and oleophobic. “For the best results, it is preferred to use a second substance, which is an anionic fluorocarbon compound, and optimally, said second substance is a fluoro-alkyl-sulphonate, for example a fluoro-alkyl-sulphonate in which the alkyl has a long chain (C14 to C18).” (See Column 4, lines 8-13) U.S. Pat. No. 6,632,508 (Pellerite et al.) teaches treating reflective beads with a polyfluoropolyether compound comprising at least one polar group or a polar group-containing organic radical.

### SUMMARY

There is a desire to move away from fluorinated materials in products due to changes in the regulatory requirements around fluorinated compounds. The process as disclosed herein can be used to partially embed microspheres into a polymeric layer without the use of fluorinated compounds.

In one aspect, a process for making an article is discussed. The process comprises applying a curable composition to a substrate to form a coated substrate, wherein the curable composition comprises a blend of a polyol; a polyisocyanate; a functionalized (meth)acrylate comprising at least one functional group, wherein the functional group is selected from an isocyanato or hydroxy group; and a photoinitiator;
partially curing the coated substrate with actinic radiation to form a partially cured coated substrate;
contacting the partially cured coated substrate with a plurality of inorganic microspheres;
providing a time sufficient for the plurality of inorganic microspheres to partially embed in the partially cured coated substrate to form a beaded film; and
thermally curing the beaded film.

In another aspect, an article is described, the article comprising:
a binder layer comprising a first major surface and an opposing, second major surface, wherein a plurality of inorganic microspheres is localized near the first major surface and wherein at least a portion of the plurality of inorganic microspheres is partially embedded in the first major surface, wherein the binder layer is derived from a polyol; a polyisocyanate; a functionalized (meth)acrylate comprising a functional group selected from at least one of an isocyanato or hydroxy; and a photoinitiator.

The above summary is not intended to describe each embodiment. The details of one or more embodiments of the invention are also set forth in the description below. Other features, objects, and advantages will be apparent from the description and from the claims.

### DESCRIPTION OF THE FIGURES

Embodiments of the present disclosure are illustrated by way of example, and not limitation, in the accompanying drawings in which:

FIG. 1 is a schematic cross-sectional view of a beaded film according to one embodiment of the present disclosure;

FIG. 2 is a schematic cross-sectional side view of an exemplary bead film article according to the present disclosure;

FIG. 3 is a schematic cross-sectional side view of an exemplary pavement marking 30 according to the present disclosure;

FIG. 4 is a schematic cross-sectional side view of an embedded microsphere to depict lengths D and C for embedment calculations; and

FIGS. 5A-D are optical microscopy views of a cross-section of various samples: CE4 (A), EX 3 (B), EX 4 (C) and EX 5 (D).

It should be understood that numerous other modifications and embodiments can be devised by those skilled in the art, which fall within the scope and spirit of the principles of the disclosure. The schematic figures may not be drawn to scale.

### DETAILED DESCRIPTION

As used herein, the term
“a”, “an”, and “the” are used interchangeably and mean one or more; and
“and/or” is used to indicate one or both stated cases may occur, for example A and/or B includes, (A and B) and (A or B);
“catalyst” means a substance that can increase the speed of a chemical reaction;
“cure” means to alter the physical state and or chemical state of the composition to make it transform from a fluid to a less fluid state, to go from a tacky to a non-tacky state, to go from a soluble to insoluble state, to decrease the amount of polymerizable material by its consumption in a chemical reaction, or to go from a material with a specific molecular weight to a higher molecular weight;
“curable” means capable of being cured;
“partially cured” means a given material is sufficiently crosslinked to perform an interim function, but not its ultimate function, in a given application;
“fully cured” means cured to a state where the composition is suitable for use in its intended application; and
“(meth)acrylate” refers to compounds containing either an acrylate (CH₂═CHCOOR) or a methacrylate (CH₂═CCH₃COOR) structure or combinations thereof).

The term “substituted” as used herein in conjunction with a molecule in which one or more hydrogen atoms contained therein, refers to the replacement of one or more of these hydrogen atoms by one or more non-hydrogen atoms. Examples of substituents or functional groups that can be substituted include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups. The term “alkylene” as used herein refers to the divalent form of the alkyl group, which is the monovalent form, just described.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others. The term “alkenylene” as used herein refers to the divalent form of the alkenyl group, which is the monovalent form, just described.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group. The term “acylene” as used herein refers to the divalent form of the acyl group, which is the monovalent form, just described.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkylene” as used herein refers to the divalent form of the cycloalkyl group, which is the monovalent form, just described.

The term “aryl” as used herein refers to cyclic aromatic hydrocarbon groups that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof. The term “arylene” as used herein refers to the divalent form of the aryl group, which is the monovalent form, just described.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. The term “aralkylene” as used herein refers to the divalent form of the arylkyl group, which is the monovalent form, just described.

The term “alkoxy” as used herein refers to an oxygen atom connected to an alkyl group, including a cycloalkyl group, as are defined herein. Examples of linear alkoxy groups include, but are not limited to, methoxy, ethoxy, propoxy, butoxy, pentyloxy, hexyloxy, and the like. Examples of branched alkoxy include, but are not limited to, isopropoxy, sec-butoxy, tert-butoxy, isopentyloxy, isohexyloxy, and the like. Examples of cyclic alkoxy include, but are not limited to, cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith. The term “alkoxyene” as used herein refers to the divalent form of the alkoxy group, which is the monovalent form, just described.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and all three together.

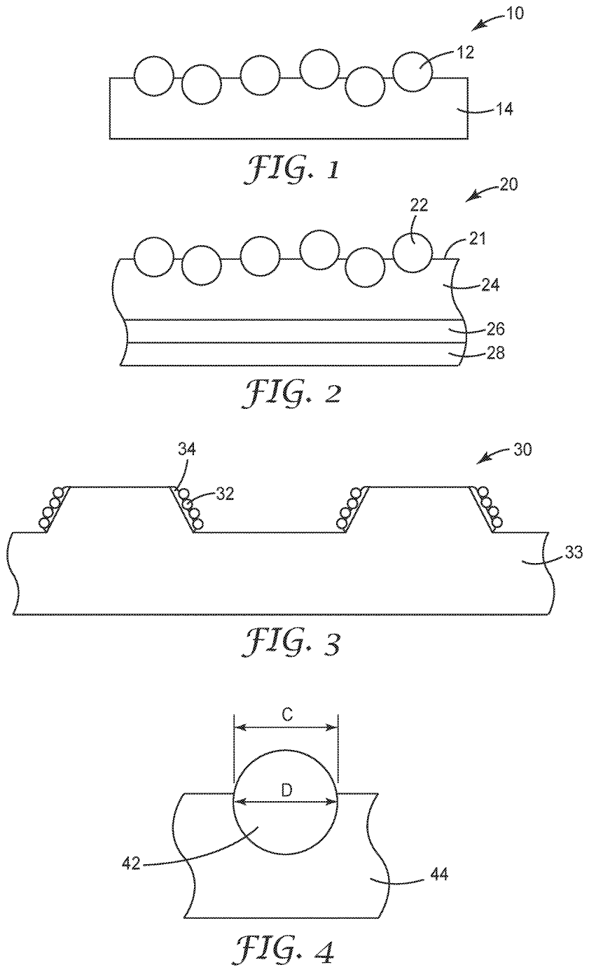

The present application is directed toward a beaded film as shown in FIG. 1. Article 10 comprises a plurality of microspheres 12 that are partially embedded in binder layer 14. The present disclosure is directed toward a novel approach to make such articles. In the present disclosure, it has been discovered that microspheres can be floated (or partially embedded) into a binder layer by first partially curing a binder reaction mixture, applying the microspheres onto the surface of the partially cured binder reaction mixture, and then further curing with thermal radiation to lock the microspheres into place.

### Binder Layer

The binder layer is derived from a curable reaction mixture comprising (a) a polyol; (b) a polyisocyanate; (c) a functionalized (meth)acrylate; and (d) a photoinitiator.

The polyol of the present disclosure is a compound comprising two or more terminal hydroxyl groups (e.g., 2, 3, 4, 6, 8, or even more hydroxyl groups). A “diol” refers to a compound having exactly two hydroxyl groups. The term polymeric diol used herein includes both polymers and small molecules having two hydroxyl (—OH) groups. Diols can be selected from the group consisting of: caprolactone diols, polycarbonate diols, polyester diols, acrylic diols, polyether diols, polyolefin diols, and mixtures thereof.

In some embodiments, the polyol is according to Formula I, having the structure

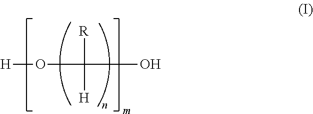

wherein R is hydrogen or a (C1-C10) alkyl group, which may be substituted or unsubstituted; n is an integer from 2 to 6 and m is an integer of at least 10. In some embodiments, R is H, methyl, ethyl, or propyl group. In some embodiments, n is 2, 3, 4, 5 or 6. In some embodiments, m is at least 10, 12, 14, 16, 18, 20 or even 25. In some embodiments, m is at most 100, 80, 70, 60, 50, 40, or even 30. Examples of such polyols include poly(oxytetramethylene) glycols, poly(oxyethylene) glycols and poly(oxypropylene) glycols.

In some embodiments, the polyol is a polyester diol. In some embodiments, the polyester diol can be a reaction product of a condensation reaction such as esterifying organic dicarboxylic acids or their anhydrides with organic diols. The dicarboxylic acids and the diols can be aliphatic or aromatic dicarboxylic acids and diols.

In examples where the polyester diol is made according to a condensation reaction, the reaction can be between one or more carboxylic acids and one or more polymeric diols. An example of a suitable carboxylic acid includes a carboxylic acid according to Formula II, having the structure:

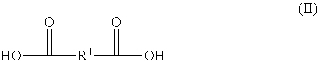

Wherein R¹ is a (C₁-C₄₀)alkylene, (C₂-C₄₀)alkylene, (C₂-C₄₀)alkenylene, (C₄-C₂₀)arylene, (C₄-C₂₀)cycloalkylene, or (C₄-C₂₀) aralkylene, which may be substituted or unsubstituted. Specific examples of suitable carboxylic acids include glycolic acid (2-hydroxyethanoic acid), lactic acid (2-hydroxypropanoic acid), succinic acid (butanedioic acid), 3-hydoxybutanoic acid, 3-hydroxypentanoic acid, terephthalic acid (benzene-1,4-dicarboxylic acid), naphthalene dicarboxylic acid, 4-hydroxybenzoic acid, 6-hydroxynaphthalane-2-carboxylic acid, oxalic acid, malonic acid (propanedioic acid), adipic acid (hexanedioic acid), pimelic acid (heptanedioic acid), ethanoic acid, suberic acid (octanedioic acid), azelaic acid (nonanedioic acid), sebacic acid (decanedioic acid), glutaric acid (pentanedioic acid), dodecanedioic acid, brassylic acid, thapsic acid, maleic acid ((2Z)-but-2-enedioic acid), fumaric acid ((2E)-but-2-enedioic acid), glutaconic acid (pent-2-enedioic acid), 2-decenedioic acid, traumatic acid ((2E)-dodec-2-enedioic acid), muconic acid ((2E,4E)-hexa-2,4-dienedioic acid), glutinic acid, citraconic acid((2Z)-2-methylbut-2-enedioic acid), mesaconic acid ((2E)-2-methyl-2-butenedioic acid), itaconic acid (2-methylidenebutanedioic acid), malic acid (2-hydroxybutanedioic acid), aspartic acid (2-aminobutanedioic acid), glutamic acid (2-aminopentanedioic acid), tartonic acid, tartaric acid (2,3-dihydroxybutanedioic acid), diaminopimelic acid ((2R,6S)-2,6-diaminoheptanedioic acid), saccharic acid ((2S,3S,4S,5R)-2,3,4,5-tetrahydroxyhexanedioic acid), mexooxalic acid, oxaloacetic acid (oxobutanedioic acid), acetonedicarboxylic acid (3-oxopentanedioic acid), arbinaric acid, phthalic acid (benzene-1,2-dicarboxylic acid), isophthalic acid, terphthalic acid, tetrahydphthalic acid, hexahydrophthalic acid, hexachloroheptanedicarboxylic acid, tetrachlorophthalic acid, diphenic acid, 2,6-naphthalenedicarboxylic acid, or a mixture thereof. Instead of these acids, their anhydrides, if they exist, may also be used. An example of a suitable diol includes a diol according to Formula III, having the structure:

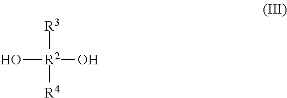

wherein R² is a (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, or (C₁-C₄₀)alkoxyene, which may be substituted or unsubstituted; and R³ and R⁴ are independently chosen from —H, —OH, (C₁-C₄₀)alkyl, (C₂-C₄₀)alkenyl, (C₄-C₂₀)aryl, (C₁-C₂₀)acyl, (C₄-C₂₀)cycloalkyl, (C₄-C₂₀)aralkyl, and (C₁-C₄₀)alkoxy, which may be substituted or unsubstituted.

In another embodiment, the polyester diol may be derived from reacting caprolactones with a polyol as described in U.S. Pat. No. 3,169,945. An example of suitable lactones that may be used include a compound according to Formula VI, having the structure:

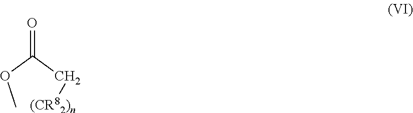

wherein R⁸ is independently selected from hydrogen or a (C1 to C10) alkyl group, cycloalkyl or alkoxy; and n is an integer of at least 1 and not more than 10, preferably n is 4, 5 or 6. Exemplary lactones include E-caprolactones, in which n has the value 4 and c-caprolactone, where n is 4 and all R substituents are hydrogen. Examples of aliphatic diols suitable for reaction with the lactone include ethylene glycol, 1,3-propanediol, 1,4-butanediol, dimethylolcyclohexane, trimethylolpropane, glycerol, and neopentyl glycol.

An example of another suitable polyol includes a compound according to Formula IV, having the structure:

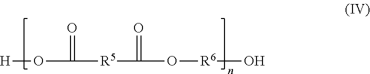

wherein R⁵ and R⁶ are independently chosen from (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, or (C₁-C₄₀)alkoxyene, which may be substituted or unsubstituted; and n is a positive integer greater than or equal to 1 (for example, greater than 2, 4, 5, or even 10).

An example of another suitable polyol includes a compound according to Formula V, having the structure:

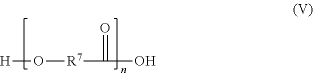

wherein R⁷ is a (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, or (C₁-C₄₀)alkoxyene, which may be substituted or unsubstituted; and n is a positive integer greater than or equal to 1 (for example, greater than 2, 4, 5, or even 10). In specific examples, the polyester polyol includes one or more of polyglycolic acid (poly[oxy(1-oxo-1,2-ethanediyl)]), polybutylene succinate (poly(tetramethylene succinate)), poly(3-hydroxybutyrate-co-3-hydroxyvalerate), polyethylene terephthalate (poly(ethyl benzene-1,4-dicarboxylate)), polybutylene terephthalate (poly(oxy-1,4-butanediyloxycarbonyl-1,4-phenylenecarbonyl)), polytrimethylene terephthalate (poly(trimethylene terephthalate); poly(oxy-1,3-propanediyloxycarbonyl-1,4-phenylenecarbonyl)), polyethylene naphthalate (poly(ethylene 2,6-naphthalate)), poly(1,4-butylene adipate), poly(1,6-hexamethylene adipate), poly(ethylene-adipate), mixtures thereof, and copolymers thereof. Examples of commercially available polyols include the CAPA family of polyols available from Ingevity, North Charleston, SC.

In some embodiments, the polyol is an aliphatic polyol. In some embodiments, the polyol is linear. In some embodiments, the polyol has a molecular weight of 400 to 3,000 Daltons as known in the art.

In some embodiments, the reaction mixture comprises at least 10, 12, 15, 18, or even 20 wt % to at most 22, 25, or even 30 wt % of the polyol.

The polyisocyanate of the present disclosure is a compound having at least two isocyanate groups (e.g., 2, 3, 4, 6, 8, or even more isocyanate groups). Suitable polyisocyanates include diisocyanates and polyisocyanates with an isocyanate functionality of greater than 2. In exemplary embodiments, the polyisocyanate is a primary polyisocyanate, such as a primary aliphatic polyisocyanate. Primary polyisocyanates having an isocyanate functionality of 3 or more can be made from primary diisocyanates, such as 1,6-hexamethylene diisocyanate, trimethyl-hexamethylene diisocyanate, 1,4-tetramethylene diisocyanate, 1,3-xylene diisocyanate, 1,4-xylene diisocyanate, 1,12-dodecamethylene diisocyanate, 2-methylpentamethylene diisocyanate, or 1,4-cyclohexane dimethylene diisocyanate. Examples of commercially available polyisocyanates include the Desmodur N family of aliphatic isocyanates, available from Covestro LLC, Pittsburgh, PA.

A diisocyanate refers to a molecule having two isocyanate (—N═C═O) functional groups. An example of a suitable diisocyanate includes a diisocyanate according to Formula VII:

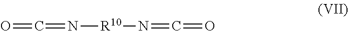

wherein R¹⁰ is a C₁-C₄₀)alkylene, (C₂-C₄₀)alkenylene, (C₄-C₂₀)arylene, (C₄-C₂₀)arylene-(C₁-C₄₀)alkylene-(C₄-C₂₀)arylene, (C₄-C₂₀)cycloalkylene, or (C₄-C₂₀)aralkylene, which may be substituted or unsubstituted. Exemplary diisocyanates include: dicyclohexylmethane-4,4′-diisocyanate, isophorone diisocyanate, hexamethylene diisocyanate, 1,4-phenylene diisocyanate, 1,3-phenylene diisocyanate, m-xylylene diisocyanate, tolylene-2,4-diisocyanate, toluene 2,4-diisocyanate, tolylene-2,6-diisocyanate, poly(hexamethylene diisocyanate), 1,4-cyclohexylene diisocyanate, 4-chloro-6-methyl-1,3-phenylene diisocyanate, hexamethylene diisocyanate, toluylene diisocyanate, diphenylmethane 4,4′-diisocyanate, 1,4-diisocyanatobutane, 1,8-diisocyanatooctane, 2,6-toluene diisocyanate, 2,5-toluene diisocyanate, 2,4-toluene diisocyanate, m-phenylene diisocyanate, p-phenylene diisocyanate, methylene bis(o-chlorophenyl diisocyanate, methylenediphenylene-4,4′-diisocyanate, (4,4′-diisocyanato-3,3′,5,5′-tetraethyl) diphenylmethane, 4,4′-diisocyanato-3,3′-dimethoxybiphenyl (o-dianisidine diisocyanate), 5-chloro-2,4-toluene diisocyanate, 1-chloromethyl-2,4-diisocyanato benzene, tetramethyl-m-xylylene diisocyanate, 1,6-diisocyanatohexane 1,12-diisocyanatododecane, 2-methyl-1,5-diisocyanatopentane, methylenedicyclohexylene-4,4′-diisocyanate, 3-isocyanatomethyl-3,5,5-trimethylcyclohexyl isocyanate, 2,2,4-trimethylhexyl diisocyanate, trimethylene diisocyanate, tetramethylene diisocyanate, pentamethylene diisocyanate, hexamethylene diisocyanate, propylene diisocyanate, ethylethylene diisocyanate, 2,3-dimethylethylene diisocyanate, 1-methyltrimethylene diisocyanate, 1,3-cyclopentylene diisocyanate, 1,4-cyclohexylene diisocyanate diisocyanate, 1,2-diisocyanate diisocyanate, 1,2-cyclohexylene diisocyanate, 1,2-diisocyanate, 1,5-naphthylene diisocyanate, 1,4-naphthlyene diisocyanate, 1-isocyanatomethyl-5-isocyanato-1,3,3-trimethylcyclohexane, bis (4-isocyanatocyclohexyl) methane, bis (4-isocyanatophenyl) methane, 4,4′-diisocyanatodiphenyl ether and 2,3-bis (8-isoeyanatooctyl)-4-octyl-5-hexylcyclohexene, or a mixture thereof.

In some embodiments, the reaction mixture comprises at least 20, 25, 30, 35, or even 40 wt % to at most 42, 45, 48, 50, or even 55 wt % of the polyisocyanate.

Also included in the curable binder reaction mixture is a (meth)acrylate compound comprising at least one functional group. The functional group refers to a group which can react to form a polyurethane. Such functional groups include an isocyanato or a hydroxy group. In some embodiments, the functionalized (meth)acrylate compound is aliphatic. In some embodiments, the functionalized (meth)acrylate compound comprises at least two functional groups. Exemplary functionalized (meth)acrylates include an aliphatic urethane acrylate, and a hydroxyalkyl acrylate. Exemplary functionalized (meth)acrylates include a caprolactone acrylate available under the trade designation “SR495B” from Sartomer, Exton, PA; isocyanate functional aliphatic urethane acrylate available under the trade designation as “EBECRYL 4150” and hydroxyl functional aliphatic urethane acrylate available under the trade designation as “EBECRYL 8210” from Allnex, Alpharetta, GA.

In some embodiments, the functionalized (meth)acrylate compound is present in the reaction mixture in an amount of at least 3, 4, 5, 10, 11, 12, 15, or even 18 wt % to at most 20, 22, 25, 28, or even 30 wt % based on the overall weight of the reaction mixture used to form the binder layer. The amount of functionalized (meth)acrylate compound used can varying depending on the type of functionalized (meth)acrylate compound and/or the contents of the reaction mixture. In some embodiments, the functionalized (meth)acrylate compound is present in the reaction mixture in an amount of at least 3, 4, or even 5 wt % to at most 6, 6.5, 7, 7.8, or even 8 wt % based on the overall weight of the reaction mixture used to form the binder layer. In some embodiments, the functionalized (meth)acrylate compound is present in the reaction mixture in an amount of at least 18.2, 18.4, 18.5, or even 18.6 wt % to at most 18.8, 18.9, 19, 20.2, 20.4, 20.6, 20.8, or even 21 wt % based on the overall weight of the reaction mixture used to form the binder layer.

The curable reaction mixture also includes at least one photoinitiator, which in the presence of actinic radiation, creates a free radical to initiate the polymerization of the functionalized (meth)acrylate compound. Such photoinitiators include benzoin ethers such as benzoin methyl ether and benzoin isopropyl ether, substituted acetophenones such as 2, 2-dimethoxyacetophenone, available under the trade designation “IRGACURE™ 651” photoinitiator (Ciba Specialty Chemicals); bis (2,4,6-trimethylbenzoyl)-phenylphosphine oxide available under the trade designation “IRGACURE 819” (BASF corp.); 2,2 dimethoxy-2-phenyl-1-phenylethanone, available under the trade designation “ESACURE KB-1” photoinitiator (Sartomer Co.; West Chester, PA); 1-[4-(2-hydroxyethoxy)phenyl]-2-hydroxy-2-methyl-1-propan-1-one, available under the trade designation “IRGACURE 2959” (Ciba Specialty Chemicals); and dimethoxyhydroxyacetophenone; substituted α-ketols such as 2-methyl-2-hydroxy propiophenone; aromatic sulfonyl chlorides such as 2-naphthalene-sulfonyl chloride; and photoactive oximes such as 1-phenyl-1,2-propanedione-2-(O-ethoxy-carbonyl)oxime. The photoinitiator is typically selected based on the wavelength output of the source. In some embodiments, the photoinitiator can absorbs in the ultraviolet wavelength, for example, from 100 to 400 nm. In some embodiments, the photoinitiator can absorbs in the visible wavelength, for example, from 400 to 800 nm. In some embodiments, more than one photoinitiator is used. Exemplary total amounts of photoinitiator used include from at least 0.1, 0.2, 0.5, 1, 1.5, 2, 2.5, or even 3 wt % to at most 3.5, 4, 4.5, 5, 6, 8, or even 10 wt % based on the overall weight of the reaction mixture used to form the binder layer.

Optionally, the curable composition may include a catalyst to facilitate reaction between the polyisocyanate and polyol components and/or the functionalized (meth)acrylate component. Useful catalysts include aluminum-, bismuth-, tin-, vanadium-, zinc-, mercury-, and zirconium-based catalysts, amine catalysts, and mixtures thereof. Preferred catalysts include tin-based catalysts, such as dibutyl tin compounds. Especially preferred are catalysts selected from the group consisting of dibutyltin diacetate, dibutyltin dilaurate, dibutyltin diacetylacetonate, dibutyltin dimercaptide, dibutyltin dioctoate, dibutyltin dimaleate, dibutyltin acetonylacetonate, and dibutyltin oxide.

Exemplary amounts of the catalyst can include from at least 0.001, 0.005, 0.01, 0.02, 0.05, or even 0.08 wt % to at most 0.1, 0.12, 0.15, 0.17, or even 0.2 wt % based on the overall weight of the reaction mixture used to form the binder layer.

For some applications, such as pavement marking, the reaction mixture used to form the binder layer may comprise pigments or other coloring agents. Such pigments include titanium dioxide, which can be used to obtain a white color or organic yellow opaque pigments such as organic yellow opaque pigments (available under a trade designations SUNBRITE YELLOW 74 available from Sun Chemical, Parsippany-Troy Hills, NJ or DALAMAR YELLOW available from Heubach GmbH, Langelsheim, Germany), which can be used to obtain a yellow color.

In some embodiments, the reaction mixture for the binder layer is substantially free of a solvent (for example, comprising less than 1, 0.5, 0.1, or even 0.05 wt % in the reaction mixture), wherein a solvent is defined as a liquid that does not react with the components, but can dissolve or disperse the components or adjust the viscosity of the curable composition. Such solvents include ether acetate, propylene glycol monomethylether acetate, ketones (such as acetone, methyl ethyl ketone, and methyl isobutyl ketone), benzene derivatives, and mixtures thereof.

### Microspheres

The article of the present disclosure comprises a plurality of inorganic microspheres (referred to hereinafter as microspheres) localized near a first major surface as shown in FIG. 1. The microspheres useful in the present disclosure comprise glass, glass ceramics, ceramics, metals, and combinations thereof. Glass is an amorphous material, while ceramic refers to a crystalline or partially crystalline material. Glass ceramics have an amorphous phase and one or more crystalline phases. These materials are known in the art.

In some embodiments, the microspheres are glass beads. Common industrial glasses could be of varying refractive indices depending on their composition. Soda lime silicates and borosilicates are some of the common types of glasses. Borosilicate glasses typically contain boria and silica along with other elemental oxides such as alkali metal oxides, alumina etc. Some glasses used in the industry that contain boria and silica among other oxides include E glass, and glass available under the trade designation “NEXTERION GLASS D” from Schott Industries, Kansas City, Missouri, and glass available under the trade designation “PYREX” from Corning Incorporated, New York, New York.

In general, ceramic microsphere optical elements are comprised of metal oxides that are substantially transparent. Suitable metal oxides include Al₂O₃, SiO₂, ThO₂, Sn₂, TiO₂, Y₂O₃ and ZrO₂ with the oxides of zirconium, silicon, and titanium being preferred. The ceramic microspheres can exhibit a range of properties, depending on the kind and amounts of the various metal oxides employed as well as the method of manufacture Preferred, however, are dense microspheres having substantially no open porosity that have an average hardness greater than sand.

Ordinary glass beads typically have a density of about 2.5 g/mL and a refractive index of about 1.5. “High index” beads refers to beads having a density of about 3.5 g/mL and a refractive index of about 1.9, whereas “super high index” typically refers to beads having a density of about 5 g/mL and a refractive index of about 2.3 or higher.

The microspheres for use in the present disclosure are substantially spherical, for example, having a sphericity of at least 80%, 85%, or even 90%, where sphericity is defined as the surface area of a sphere (with the same volume as the given particle) divided by the surface area of the particle, reported as a percentage.

Preferable examples of the spherical particles include fused alumina, alumina produced by the Bayer process, zirconia, and eutectic mixtures thereof.

The microspheres are preferably free of defects. As used herein, the phrase “free of defects” means that the microspheres have low amounts of bubbles, low amounts of irregular shaped particles, low surface roughness, low amount of inhomogeneities, low amounts of undesirable color or tint, or low amounts of other scattering centers. The microspheres disclosed herein are not glass bubbles, which are a hollow core encased in a glass sphere.

Preferably, the microspheres used in the present disclosure are transparent or translucent in nature to enable reflectance of light of the resulting article. The term transparent means that when viewed under an optical microscope (e.g., at 100×) the microspheres have the property of transmitting rays of visible light so that bodies beneath the microspheres, such as bodies of the same nature as the microspheres can be clearly seen through the microspheres, when both are immersed in oil of approximately the same refractive index as the microspheres. The outline, periphery, or edges of bodies beneath the microspheres are clearly discernible. Although the oil should have a refractive index approximating that of the microspheres, it should not be so close that the microspheres seem to disappear as would be the case for a perfect match.

In another embodiment, the microspheres have a refractive index of less than 1.30, 1.40, 1.49, 1.50, 1.55, 1.60, 1.70, 1.80, or even 1.90. The refractive index may be determined by the standard Becke line method.

In some embodiments, a useful range of average microsphere diameters is at least 50, 75, 100, or even 150 μm (micrometers); at most 200, 300, 400, or even 500 μm. The microspheres may have a unimodal or multi-modal (e.g., a bimodal) size distribution depending on the application. In some embodiments, to calculate the “average diameter” of a mixture of microspheres one would sieve a given weight of particles such as, for example, a 100 gram sample through a stack of standard sieves. The uppermost sieve would have the largest rated opening and the lowest sieve would have the smallest rated opening. Alternately, average diameter can be determined using any commonly known microscopic methods for sizing particles. For example, optical microscopy or scanning electron microscopy, and the like, can be used in combination with any image analysis software. For example, software commercially available as free ware under the trade designation “IMAGE J” from NIH, Bethesda, Maryland.

In some embodiments, the plurality of microspheres has a difference in size distribution not more than 40% (30% or even 20%) based on the average microsphere diameter.

In some embodiments, the microspheres comprise a surface modification as is known in the art to improve the adhesion of the microspheres to the binder layer. Such treatments include those selected from the group consisting of silane coupling agent, titanate, organo-chromium complex, and the like, to maximize the adhesion of the microspheres to the binder layer. Preferably, the coupling agent comprises a nucleophilic group which is present on the surface of the microsphere and can react with the isocyanates in the reaction mixture of the binder layer. Exemplary coupling agents may include aminosilanes. Having a nucleophilic group present on the surface of the microsphere will enable the isocyanates from the binder reaction mixture to form covalent bonds, thereby improving the adhesion between the binder layer and the plurality of microspheres.

In some embodiments, the treatment level for such coupling agents is on the order of 50 to 700 parts by weight coupling agent per million parts by weight microspheres. Microspheres having smaller diameters would typically be treated at higher levels because of their higher surface area. Treatment is typically accomplished by spray drying or wet mixing a dilute solution such as an alcohol solution (such as ethyl or isopropyl alcohol, for example) of the coupling agent with the microsphere, followed by drying in a tumbler or auger-fed dryer to prevent the microspheres from sticking together. One skilled in the art would be able to determine how to best treat the microspheres with the coupling agent.

### Method of Making

Disclosed herein is a novel method of making a beaded article. The components of the binder layer reaction mixture as described above are mixed together. It may be preferable to mix all components minus the isocyanate-containing component(s) together first to ensure a homogeneous mixture before any pre-reaction occurs. Then, the isocyanate-containing component(s) may be added, mixed, and the curable composition may then be coated onto a desired support. Such supports may include a transparent base or a release-coated support, from which after hardening/solidification of the binder layer, the beaded film is removed from the release-coated support. Coating onto the support can be done using conventional equipment such as a knife coater, roll coater, reverse roll coater, notched bar coater, curtain coater, rotogravure coater, or rotary printer. Coatings can be hand spread or automated and may be carried out according to either a batch or continuous process. The viscosity of the binder layer reaction mixture can be adjusted as needed to suit the type of coater used.

After coating, the reaction mixture is exposed to actinic radiation to partially cure the binder layer. As used herein “partially cured” means that the binder layer is in a state less than fully cured. Typically, the reaction mixture is cured to a viscosity to enable the plurality of microspheres to have a controlled sink into the partially cured binder layer.

As used herein, actinic radiation refers to electromagnetic radiation in the ultraviolet, visible, and/or infrared wavelengths. In some embodiments, the curable composition is exposed to wavelengths from at least 180, 200, 210, 220, 240, 260, or even 280 nm; and at most 700, 800, 1000, 1200, or even 1500 nm. In some embodiments, the curable composition is exposed to wavelengths from at least 180, 210, or even 220 nm; and at most 340, 360, 380, 400, 410, 450, or even 500 nm. In other embodiments, the curable composition is exposed to wavelengths from at least 400, 420, or even 450 nm; and at most 700, 750, or even 800 nm. In other embodiments, the curable composition is exposed to wavelengths from at least 800, 850, or even 900 nm; and at most 1000, 1200, or even 1500 nm. Actinic radiation includes electromagnetic radiation in the ultraviolet, visible, and/or infrared wavelengths.

Any light source may be employed as a radiation source, such as, a high or low pressure mercury lamp, a cold cathode tube, a black light, a light emitting diode, a laser, and/or a flash light. Of these, the preferred source is one exhibiting a relatively long wavelength UV-contribution having a dominant wavelength of 300-400 nm. UV radiation is generally classed as UV-A, UV-B, and UV-C as follows: UV-A: 400 nm to 320 nm; UV-B: 320 nm to 290 nm; and UV-C: 290 nm to 100 nm.

In some embodiments, the power of the actinic radiation is 10 to 1000 watts, which can depend on the radiation source used and any filters used. In some embodiments, the power of the actinic radiation is 10 to 100 watts. In other embodiments, the power of the actinic radiation is 200 to 600 watts.

In some embodiments, the intensity of the actinic radiation is at least 0.2, 0.3, 0.5, or even 1 watt/cm²; and at most 3, 5, 8, 10, or even 15 watts/cm².

After partially curing the binder layer reaction mixture, the plurality of microspheres are then applied to the top surface of the partially cured binder layer. In some embodiments, the curable composition is partially cured to about 30% to even 90% of its fully cured state. The microspheres may be applied to the surface using any technique known in the art including dropping, spraying, cascade coating, sprinkling, etc. A sufficient amount of time, as used herein, refers to the amount of time needed for the microspheres to achieve the desired sink level (i.e., how far they are embedded) into the partially cured binder layer. Typically, the plurality of microspheres are embedded in the binder layer to at least 10, 20, 30, 40, 50 or even 52% of their diameter, and at most 80, 75, 70, or even 65% of their diameter. The amount of sink may be readily determined by microscopy as described in the Examples below. An exemplary amount of time for sinking the microspheres could include instantaneously after contact with the partially cured binder layer or at least 1, 5, 10, 30, 60, or even 120 seconds or even longer. In some embodiments, the microspheres reach their desired sink level in 1, 5, or even 10 minutes. In some embodiments, the microspheres reach an equilibrium, wherein the partially embedded microspheres no longer sink. In some embodiments, the microspheres can be stable without further sinking for upwards of 1, 2, 6, 12, or even 24 hours, enabling time between the sinking of the microspheres before thermally curing the article.

In some embodiments, the curable composition is selected such that when the desired microspheres (e.g., microspheres having a D50 distribution 250 micrometers and a density of 3.8 g/cc) are applied to the surface of the curable composition, the microspheres sink on average to between 10 to 80% of their diameter, preferably 20 to 70%, or even more preferably 30 to 70% of their diameter. For example, after applying the microspheres to the surface of the curable composition, the microspheres are left to sink from 0.01, 0.1, 0.5, 1, 2, 5, or even 10 minutes at ambient temperature and pressure to achieve an average sink of between 10 to 90% of their diameter or even 30 to 70% of their diameter, or even 50 to 70% of their diameter.

After the desired level of sink is reached, the partially cured binder layer comprising the embedded microspheres is then exposed to thermal radiation to further cure the binder layer. In general, the binder layer is preferably cured at pre-determined temperatures of from at least 25, 30, 35, 40, 50, or even 60° C. to at most 80, 90, 100, 110, 120, 130, 140, 150, 180, or even 200° C. Residence time at a given temperature, while highly dependent on the temperature, can be from at least 1, 2, 3, 4, or even 5 minutes to at most 60, 40, 30, 20, 15, or even 10 minutes. The binder layer is preferably subjected to residence times and temperatures, or temperature ranges, that balance curing effectiveness with overall throughput and energy efficiency. The beaded article is thermally cured to be fully cured and/or achieve a sufficient cure, wherein the microspheres no longer move within the binder layer and the binder layer is of sufficient crosslinking to retain the microspheres.

Although not wanting to be limited by theory, it is believed that irradiation causes radical formation through breakdown of the photoinitiator, which polymerizes the (meth)acrylate compound. The polymerization changes the viscoelastic properties of the reaction mixture of the binder layer such that it behaves more solid-like, but still retains some liquid character so as to allow partial, but not complete sinking of the microspheres in the binder layer. Upon thermal exposure, the polyol and isocyanate functionalities react to form a polyurethane as the fully crosslinked solid binder layer.

### Article

The article of the present disclosure comprises a plurality of microspheres partially embedded into the binder layer as shown in FIG. 1.

In the resulting articles of the present disclosure, the plurality of microspheres are localized to one side of the binder layer and are partially embedded into the binder resin layer. A portion of each of the microspheres projects outwardly from the surface of the binder resin layer to provide enhancement to a surface, for example add optical properties such as reflectivity. In some embodiments, at least 10% or even 20% of the microsphere diameter protrude from the binder resin layer surface.

In some embodiments, in the resulting articles of the present disclosure, the plurality of microspheres cover more than 10, 20, 30, 40, 45, or even 50%; and less than 60, 70, 75, 80, 90, or even 95% of the surface of the binder resin layer.

Unlike the transfer process, wherein beaded films are made by transferring a monolayer of microspheres from a carrier film onto a binder layer, such as disclosed in U.S. Pat. Publ. No. 2020-0031092 (Walker et al.), the process of the present disclosure can make bead films more efficiently, by directly applying the loose microspheres onto the binder layer without the need of a transfer step. However, due to the variability of the sinking process of the present disclosure, the apexes of each of the exposed microspheres as shown in FIG. 1 may not be located along the same plane. U.S. Pat. Publ. No. 2020-0031092 (Walker et al.) describes a surface profilometry method for measuring the variability in the height of the exposed microspheres. The variability is reported as envelop R_{q} and envelope Rₚ. The envelope R_{q} is the standard deviation of the height values of the surface envelope defined by the apex of the microspheres and envelope Rₚ is the maximum peak height of the microspheres. Lower values of Rₚ and R_{q} indicated that the surface is more uniform. In some embodiments, the resultant bead films of the present disclosure have a surface texture that has an envelope Rq of more than 3.0, 2.75, 2.5, or even 2.0 micrometers. In some embodiments, the resultant bead films of the present disclosure have a surface texture that has an envelope Rp of more than 8.0, 7.5, 6.5, 6.0, 5.5, or even 5.0 micrometers.

As fluorinated polymer is not used to coat the microspheres nor added to the binder layer, in some embodiments, the bead films of the present disclosure are substantially free of fluorinated polymer, wherein substantially free means comprising less than 0.1, 0.01, or even 0.001% by weight or even no fluoropolymer is detectable using techniques known in the art such as x-ray photoelectron spectroscopy or TOF-SIMS (time of flight secondary ion mass spectroscopy).

The process of the present disclosure can be employed for producing a variety of bead films. In some embodiments, the bead films of the present disclosure are used in reflective products or articles such as, for example, pavement markings, and pavement marking tapes.

In some embodiments, the articles of the present disclosure are retroreflective. Retroreflectivity of an article can be measured based on the geometry of the source. In applications, such as pavement marking, the viewing is horizontal and the light source is at a more oblique angle. In these instances, the retroreflectivity of the article can be expressed in terms of its coefficient of retroreflected luminance (R_{L}) as described and determined in ASTM E1710-18 “Standard Test Method for the Measurement of Retroreflective Pavement Marking Materials with CEN-Prescribed Geometry Using a Portable Retroreflectometer”. In some embodiments, the articles of the present disclosure have a coefficient of retroreflected luminance of greater than or equal to 50, 100, 200, 300 or even 500 millicandelas/lux/square meter using an entrance angle of 88.76 degrees, an observation angle of 1.05 degrees, and a viewing angle of 0 degrees when measured by ASTM E1710-18 at ambient temperature. Generally, high amounts of a coefficient of retroreflected luminance of are desired, for example, even higher than 700, 800, 900, 1000, 2000, or even 2500 millicandelas/lux/square meter. Typically, in the retroreflective articles disclosed herein, such as pavement markings, and pavement marking tapes, retroreflectivity is achieved via scatter from pigments such as titanium dioxide or mica or mica-like particles, which are added to the binder layer.

Shown in FIG. 2 is one embodiment of a bead film article according to the present disclosure. Article 20 comprises a plurality of microspheres 22, partially embedded in a first major surface 21 of binder layer 24. In some embodiments, binder layer 24 is contacted with support layer 26 and adhesive layer 28. In the instance wherein FIG. 2 is a pavement marking sheet, the binder layer can comprise pigments to cause retroreflectivity of the article. The support layer 26 is used to provide mechanical support to the binder layer comprising microspheres. The support layer may be flexible and resistant to puncture which includes elastomers such as acrylonitrile-butadiene polymer, polyurethane, or neoprene rubber. Adhesives can include pressure sensitive, heat or solvent activated, or contact adhesives, which can be used to attach the bead film article to a substrate, such as road surface. In some embodiments, the pavement marking comprises base 33 having a plurality of projections, wherein binder layer 34 with partially embedded microspheres 32 are discontinuously located on the sides of the projections as shown in FIG. 3. Such a process for making a retroreflective sheet is described in U.S. Pat. No. 4,988,541 (Hedblom), herein incorporated by reference.

Objects and advantages of this disclosure are further illustrated by the following non-limiting examples, but the particular materials and amounts thereof recited in these examples, as well as other conditions and details, should not be construed to unduly limit this disclosure.

### Examples

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods.

The following abbreviations are used herein: cm=centimeter, fpm=feet per minute, in =inch, m=meter, mJ=milliJoule, mm=millimeter, nm=nanometer, rpm=revolutions per minute, and W=Watt

TABLE 1
Materials List

| Abbreviation | Description and Source |
|---|---|
| SR495B | Caprolactone acrylate available as “SR495B” from Sartomer, |
| | Exton, Pennsylvania |
| CAPA 3031 | Polyester polyol available as “CAPA 3031“ from Ingevity, North |
| | Charleston, South Carolina |
| TI-PURE R-960 | Rutile titanium dioxide pigment powder available as “TI-PURE |
| | R-960” from Chemours, Johnsonville, Tennessee |
| PURMOL 3ST | Synthetic zeolite desiccant available as “PURMOL 3ST” from |
| | Zeochem LLC, Louisville, Kentucky |
| DISPERBYK-111 | Phosphoric acid ester wetting and dispersing additive available as |
| | “DISPERBYK-111” from BYK USA Incorporated, Wallingford, |
| | Connecticut |
| AEROSIL R 972 | Fumed silica treated with dimethyldichlorosilane available as |
| | “AEROSIL R 972” from Evonik North America, Parsippany, |
| | New Jersey |
| DABCO T-12 | Dibutyltin dilaurate available as “DABCO T-12” from Evonik |
| | North America |
| IRGACURE 819 | Bis (2,4,6-trimethylbenzoyl)-phenylphosphine oxide available as |
| | “IRGACURE 819c” from BASF Corporation, Florham Park, |
| | New Jersey |
| ESACURE ONE | Difunctional alpha hydroxy ketone available as “ESACURE |
| | ONE” from IGM Resins, Charlotte, North Carolina |
| DES N100A | Aliphatic polyisocyanate available as “DESMODUR N100A” |
| | from Covestro, Pittsburgh, Pennsylvania |
| PET | 2 mil (51 micron) polyethylene terephthalate film available as |
| | “SCOTCHPAK POLYESTER FILM” from 3M Company, St. |
| | Paul, Minnesota |
| EB 4150 | Isocyanate functional aliphatic urethane acrylate available as |
| | “EBECRYL 4150” from Allnex, Alpharetta, Georgia |
| EB 8210 | Hydroxyl functional aliphatic urethane acrylate available as |
| | “EBECRYL 8210” from Allnex |
| 3-aminopropyltriethoxysilane | Available from Gelest Inc., Morrisville, Pennsylvania |
| Microspheres | Non-vitreous, solid, transparent ceramic microspheres made |
| | according to the teachings of U.S. Pat. No. 4,564,556 (Lange) |

### Test Methods

### Microscope Method to Measure % Embedment of Microspheres

A representative area of a bead-coated binder film was cut with scissors to give a fresh cross section of the construction that was then imaged with an optical microscope at 150×. The % embedment (sink) of individual microspheres as a percentage of their diameters was calculated as

$$\% embedment = 0.5 \times [ 1 \pm \frac{sqrt ( {D}^{2} - {C}^{2} )}{D} ] \times 100$$

wherein sqrt refers to square root, where D is the diameter of the microsphere, and C is the chord connecting the contact line of the binder 44 on either side of the microsphere 42 as shown in FIG. 4. The positive root is used when the microsphere was sunk to more than the microsphere's equator and the negative root when sunk to less than the microsphere's equator. The % sink value for a sample was calculated as the average value of all measurable microspheres in two representative cross sectional area images recorded at 150×, resulting in an average of values for between 10 and 16 individual microspheres.

### Index of Refraction

Index of refraction of the microspheres was measured according to T. Yamaguchi, “Refractive Index Measurement of High Refractive Index Beads,” Applied Optics Volume 14, Number 5, pages 1111-1115 (1975).

### Microsphere Particle Size Distribution

Microsphere particle size distribution was determined using a Mastersizer 3000 particle size analyzer with Aero S module obtained from Malvern Panalytical, Worcestershire, United Kingdom. An aspirated dispersion of microspheres is generated by the device and then light scattering patterns are measured to determine the particle size distribution of the sample. Data reported is the size at which a given volume fraction of the particles are below the referenced threshold. For an example in a sample with a D10 of 100 micrometers (microns, mm) 10% of the volume of the sample has a particle size less than 100 microns.

### Microsphere Density

Microsphere density was determined by using a AccuPyc II 1345 gas displacement pycnometry system obtained from Micromeritics Instrument Corporation Norcross, Georgia. Approximately 20 grams of sample was loaded into the sample cup and the instruments standard density analysis was performed. Particle size distribution, density, and refractive index of the microspheres are reported in Table 2, below.

TABLE 2

| PARTICLE SIZE DISTRIBUTION | | | DENSITY | REFRACTIVE |
|---|---|---|---|---|
| D10 microns | D50 microns | D90 microns | (g/cc) | INDEX |
| 177 | 241 | 331 | 3.86 | 1.78 |

### Surface Treatment of the Microspheres

The microspheres were surface treated with 3-aminopropyltriethoxysilane to promote adhesion to the binder. The microspheres were charged to a container containing a sufficient amount of 2 weight percent (aqueous) 3-aminopropyltriethoxysilane solution to treat them at 100 to 900 part per million (ppm) based on the weight of the microspheres. The mixture was vigorously stirred every 5 to 10 minutes for 1 hour. Then, the microspheres were filtered from the excess liquid, rinsed with deionized water, and dried in an oven at 120° C. for one hour.

### Preparatory Examples

### Preparation of Dual Cure Formulations

Dual cure polyurethane liquid binders were prepared according to Tables 3 to 5 (numbers reported in wt. %). All non-isocyanate functional components were mixed in a FLACKTEK INC. DAC 150.1 FVZ-K SPEEDMIXER, Landrum, South Carolina. Mixing was performed in two 30 seconds installments, each at 3000 rpm (revolutions per minute). Mixture was place on jar roller to remain under light agitation until time of use.

TABLE 3
Formulations with SR495B

| | Preparatory Examples | | |
|---|---|---|---|
| Materials | PE1 | PE2 | PE3 |
| SR495B | 18.03 | 18.96 | 21.43 |
| CAPA 3031 | 15.18 | 14.69 | 13.33 |
| TI-PURE R-960 | 21.35 | 21.33 | 21.43 |
| PURMOL 3ST | 0.95 | 0.95 | 0.95 |
| DISPERBYK-111 | 0.47 | 0.47 | 0.48 |
| AEROSIL R 972 | 0.47 | 0.47 | 0.48 |
| DABCO T-12 | 0.01 | 0.01 | 0.01 |
| IRGACURE 819 | 1.19 | 1.18 | 1.19 |
| ESACURE ONE | 0.71 | 0.71 | 0.71 |
| DES N100A | 41.64 | 41.22 | 39.98 |

TABLE 4
Formulations with EB 8210

| | Preparatory Examples | |
|---|---|---|
| Materials | PE4 | PE5 |
| EB 8210 | 2.83 | 6.12 |
| CAPA 3031 | 23.59 | 22.14 |
| TI-PURE R-960 | 21.23 | 21.20 |
| PURMOL 3ST | 0.94 | 0.94 |
| DISPERBYK-111 | 0.47 | 0.47 |
| AEROSIL R 972 | 0.47 | 0.47 |
| DABCO T-12 | 0.01 | 0.01 |
| IRGACURE 819 | 1.18 | 1.18 |
| ESACURE ONE | 0.71 | 0.71 |
| DES N100A | 48.57 | 46.75 |

TABLE 5
Formulations with EB 4150

| | Preparatory Examples | | | |
|---|---|---|---|---|
| Materials | PE6 | PE7 | PE8 | PE9 |
| SR495B | 1.89 | 1.89 | 1.90 | 1.89 |
| CAPA 3031 | 22.71 | 22.20 | 21.60 | 21.07 |
| TI-PURE R-960 | 21.29 | 21.25 | 21.36 | 21.31 |
| PURMOL 3ST | 0.95 | 0.94 | 0.95 | 0.95 |
| DISPERBYK-111 | 0.47 | 0.47 | 0.47 | 0.47 |
| AEROSIL R 972 | 0.47 | 0.47 | 0.47 | 0.47 |
| DABCO T-12 | 0.01 | 0.01 | 0.01 | 0.01 |
| IRGACURE 819 | 1.18 | 1.18 | 1.19 | 1.18 |
| ESACURE ONE | 0.71 | 0.71 | 0.71 | 0.71 |
| EB 4150 | 7.99 | 11.88 | 15.87 | 19.90 |
| DES N100A | 42.33 | 39.00 | 35.46 | 32.02 |

### Examples

At time of use, the isocyanate functional materials referenced in Tables 3-5 were added to the preparatory mixtures and once again mixed with FLACKTEK INC. DAC 150.1 FVZ-K SPEEDMIXER for two 30 second installments at 3000 rpm. The liquid mixture was coated (coater available from BYK Additives & Instruments, Wesel Germany, square frame 4 inch (102 mm) applicator with a 10 mil (254 micrometer) square notch) on a PET polyester film at a thickness of 0.254 mm. Immediately thereafter, the coating was exposed to ultraviolet (UV) radiation to partially cure the coating. The UV processor was an AMERICAN ULTRAVIOLET COMPANY (Murray Hill, New Jersey) unit equipped with a medium pressure mercury H bulb. Power was set to 400 W/in and the conveyor speed was 30 fpm (9.14 m/min). Total UV dosage was measured with an EIT POWER PUCK II (Leesburg, Virginia) radiometer. Over the UV-A range, 320-390 nm, the total UV dosage was 462 mJ/cm². Next, a plurality of the 3-amiinopropyltriethoxysilane-treated microspheres was cascaded over the binder, maximizing the number of adhered microspheres per surface area of binder. Immediately after contacting the microspheres to the binder, the microsphere-coated binder was then cured in an oven at 104° C. for 10 minutes. The resulting cured microsphere-coated binder film was examined under a microscope.

TABLE 6
Cured microsphere-Coated Binder Film Examples

| | Prep. Example Source | Percent Embedment by Microscopy |
|---|---|---|
| CE1 | PE1 | >95 |
| EX1 | PE2 | 33.2 |
| CE2 | PE3 | <5 |
| CE3 | PE4 | >95 |
| EX2 | PE5 | 12.1 |
| CE4 | PE6 | >95 |
| EX3 | PE7 | 52.9 |
| EX4 | PE8 | 28.5 |
| EX5 | PE9 | 11.3 |

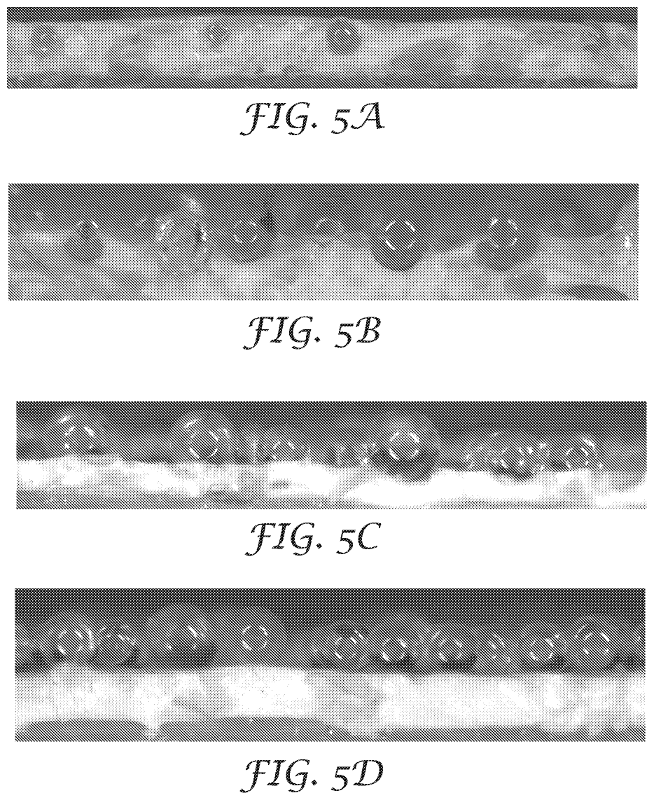

Shown in FIGS. 5A-D are pictures from an optical microscope of cross sections from various samples. FIG. 5A is CE4. FIG. 5B is EX3. FIG. 5C is EX4. FIG. 5D is EX5.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A process for making an article, the process comprising
applying a curable composition to a substrate to form a coated substrate, wherein the curable composition comprises a blend of a polyol; a polyisocyanate; a functionalized (meth)acrylate comprising at least one functional group, wherein the functional group is selected from an isocyanato or hydroxy group; and a photoinitiator;
partially curing the coated substrate with actinic radiation to form a partially cured coated substrate;
contacting the partially cured coated substrate with a plurality of inorganic microspheres;
providing a time sufficient for the plurality of inorganic microspheres to partially embed in the partially cured coated substrate to form a beaded film; and
thermally curing the beaded film.

2. The process of claim 1, wherein the curable composition is substantially free of a fluoropolymer.

3. The process of claim 1, wherein the curable composition further comprises a pigment.

4. The process of claim 1, wherein the polyol comprises a polyether or a polyesterdiol with at least two terminal hydroxyl groups.

5. The process of claim 1, wherein the polyisocyanate is an aliphatic polyisocyanate.

6. The process of claim 1, wherein the polyisocyanate is an aliphatic diisocyanate.

7. The process of claim 1, wherein the functionalized (meth)acrylate is a functionalized aliphatic (meth)acrylate.

8. The process of claim 1, wherein the functionalized (meth)acrylate comprises at least two functional groups.

9. The process of claim 1, wherein the functionalized (meth)acrylate comprises an aliphatic urethane acrylate, a hydroxyalkyl acrylate, or combinations thereof.

10. The process of claim 1, wherein the curable composition further comprises a catalyst.

11. (canceled)

12. The process of claim 1, wherein the plurality of inorganic microspheres comprises a pendant functional group that can covalently bond to the curable composition.

13. (canceled)

14. The process of claim 1, wherein the plurality of inorganic microspheres is sunk to at least 10% and at most 80% of their diameter.

15. The process of claim 1, wherein the plurality of inorganic microspheres comprises glass, ceramic, or glass-ceramic.

16. The process of claim 1, wherein the plurality of inorganic microspheres is transparent or translucent.

17. The process of claim 1, wherein the plurality of inorganic microspheres has an average diameter of at least 50 micrometer and at most 300 micrometers.

18. An article comprising:
a binder layer comprising a first major surface and an opposing, second major surface, wherein a plurality of inorganic microspheres is localized near the first major surface and at least a portion of the plurality of inorganic microspheres is partially embedded in the first major surface, wherein the binder layer is derived from a polyol; a polyisocyanate; a functionalized (meth)acrylate comprising a functional group selected from at least one of an isocyanato, hydroxy; and a photoinitiator.

19. (canceled)

20. The article of claim 18, wherein the binder layer further comprises a pigment.

21. (canceled)

22. The article of claim 18, wherein the plurality of inorganic microspheres is embedded to at least 10% and at most 80% of their diameter in the binder layer.

23. (canceled)

24. The article of claim 18, wherein the article is retroreflective.

25. A pavement marking comprising the article according to claim 18.
